(19) United States
(12) Patent Application Publication
(10) Pub. No.: US 2007/0093156 A1
(43) Pub. Date: Apr. 26, 2007

(54) METHOD OF MAKING WIDE SHEETS OF COATED SCRIM

(75) Inventor: Martin Vido, Mission (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignees: INTERWRAP INC., Mission (CA); IBCO SRL, St. Michael (BB)

(21) Appl. No.: 11/551,572

(22) Filed: Oct. 20, 2006

Related U.S. Application Data
(60) Provisional application No. 60/728,316, filed on Oct. 20, 2005.

(51) Int. Cl. B32B 27/04; B32B 27/12; B32B 5/02

(52) U.S. Cl. 442/43

(57) ABSTRACT

A sheet of coated scrim in which the scrim is seamless and the sheet has a width greater than that available using conventional manufacturing methods. A tubular scrim is flattened, coated on a first side, then coated on a second side, with a part of the coatings overhanging on one edge of the scrim. The flattened and coated tube is then slit along the opposite edge and the sheet is opened. The coating overhangs form a ridge along one side of the sheet and the ridge contains no scrim.

### CROSS-REFERENCE TO RELATED APPLICATION

This application claims the benefit of provisional application No. 60/728,316, filed Oct. 20, 2005.

### FIELD OF THE INVENTION

The invention pertains to fabrics comprising coated scrims and to methods of making them.

### BACKGROUND

Fabrics that comprise a coated scrim are used for a variety of industrial purposes, in particular for wrapping products, such as timber and steel, as housewraps in building construction, etc. The scrim is commonly a woven sheet made of polymeric tapes that give the sheet its mechanical strength, coated with a water impermeable film. Due to the size limitations of current manufacturing equipment, scrims are produced in widths up to only about 381 cm (150 inches) and where a wider fabric is required it is made by attaching together two or more panels to make a sheet of the required width. This results in a seam in the sheet product. Seams are disadvantageous in being liable to fail during use of the product. Further, the manufacturing step of making the seam adds to the cost of making the product.

### SUMMARY OF THE INVENTION

The invention provides a sheet of coated scrim in which the scrim is seamless and the sheet has a width of 381 cm or more. The sheet has a longitudinal ridge on one side having no scrim therein and comprising bonded-together coatings of the scrim.

According to another embodiment, the invention provides a method for making a sheet of coated scrim which has no seam in the scrim, in widths greater than can be made with commonly available production equipment. A tubular scrim is flattened to form a generally flattened tube and a coating is applied to one outer side of the flattened tube, extending laterally beyond a first longitudinal edge of the scrim to form a first overhang. A second coating is then applied to the other outer side of the flattened tube, again extending beyond the first longitudinal edge of the scrim to form a second overhang. The two overhangs are preferably bonded together. The tube is then slit open to form the sheet of coated scrim.

### BRIEF DESCRIPTION OF THE DRAWINGS

FIGS. 1 to 5 illustrate the successive steps carried out in the method of making the fabric of the invention.

FIGS. 3(a) and 5(a) are close-up views of portions of FIGS. 3 and 5 respectively.

### DETAILED DESCRIPTION OF THE PREFERRED EMBODIMENTS

A scrim 10 is first made on a convention circular loom. The scrim preferably comprises woven tapes of polymeric resin, for example polyolefins such as polyethylene or polypropylene. It can be made of tapes or threads of a wide range of resins. Generally, any form of scrim that can be made on a circular loom can be used in the invention.

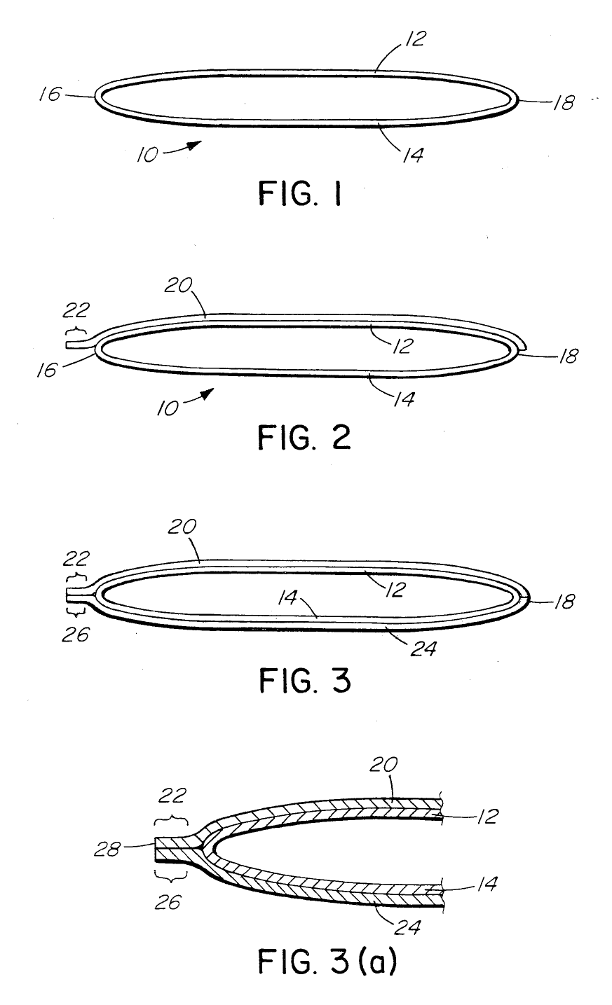

The circular scrim preferably has a circumference of at least about 381 cm (150 inches) in order to result in a sheet product having at least that width. The scrim is then generally flattened, as illustrated in FIG. 1, making a flattened tube having two outer sides 12, 14 and two longitudinal edges 16, 18 and a width measured between the edges 16 and 18.

A coating (film) 20 is then applied to one outer side 12 of the flattened scrim, as shown in FIG. 2. The coating is preferably a polymeric resin film that is extruded in a molten state onto the scrim according to conventional coating methods. Alternatively, the coating can be a film that is applied to the scrim by lamination, for example by using heated rollers or other convention methods. The film is preferably a polyolefin such as polyethylene or polypropylene. It imparts waterproofing or water-resistance to the sheet product.

The film 20 is wider than the flattened tubular scrim 10, resulting in an overhanging part 22 of the film that extends somewhat beyond the longitudinal edge 16 of the scrim.

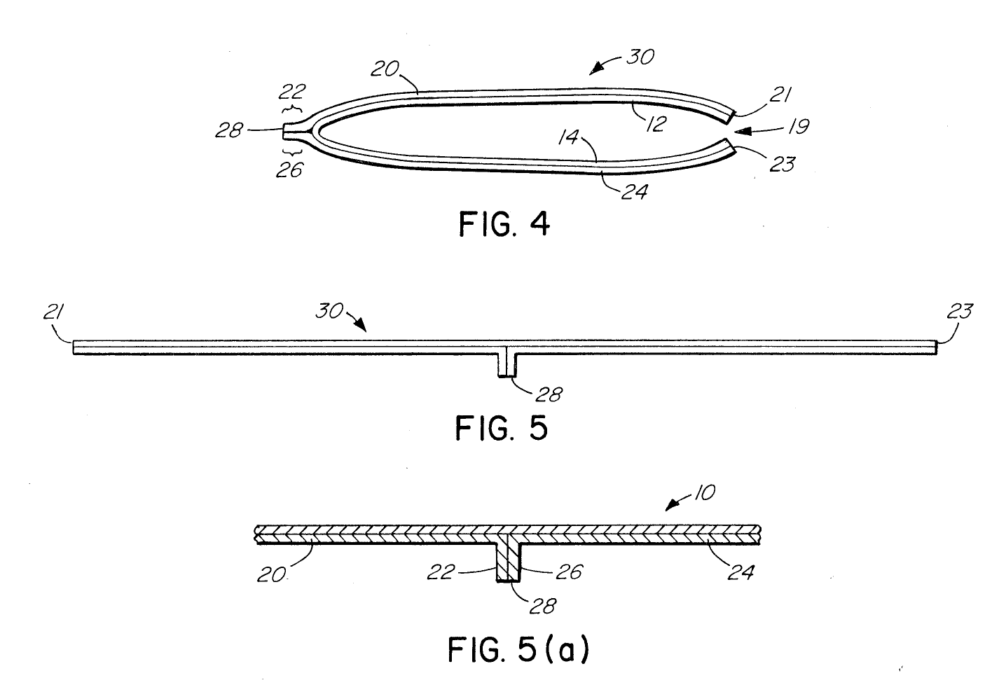

Next, a coating (film) 24 is applied to the second side 14 of the scrim, as shown in FIG. 3. Again, the film 24 is wider than the flattened scrim, resulting in an overhanging part 26 of the film 24 that extends somewhat beyond the longitudinal edge 16 of the scrim. Preferably, the two overhangs 22, 26 are bonded together in the step of laminating the second film 24 to the scrim, together making a coating end portion 28 containing no scrim.

Referring to FIG. 4, the flattened tube is then slit, as indicated at reference numeral 19, preferably along longitudinal edge 18, making a folded sheet 30 having longitudinal edges 21, 23 and with a width that is twice that of the coated flattened tube. The sheet 30 is then opened up, making a flat sheet comprising a scrim 10 that is seamless and has a coating 20, 24 on one side of it. The coated side has a longitudinal ridge 28 formed of the end portions 22, 26 of the bonded-together coatings and containing no scrim.

Since the coatings 20, 24 are bonded together along the ridge 28, the coating is continuous across the sheet.

While a number of exemplary aspects and embodiments have been discussed above, those of skill in the art will recognize that certain modifications may be made thereto. It is therefore intended that the following claims are interpreted to include all such modifications as are within their true scope.

What is claimed is:

1. A sheet of coated scrim in which the scrim is seamless and the sheet has a width of 381 cm or more.

2. The sheet of claim 1 further comprising a longitudinal ridge on one side thereof having no scrim therein, said ridge comprising bonded-together coatings of the sheet.

3. A method of making a sheet of coated scrim in which the scrim is seamless, comprising the steps of:
(a) providing a tubular scrim;
(b) flattening said tubular scrim to form a generally flattened tube having first and second outer sides and first and second longitudinal edges;
(c) applying a first coating to said flattened tube on said first outer side thereof, said coating extending laterally beyond said first longitudinal edge of said scrim to form a first overhang;
(d) applying a second coating to said flattened tube on said second outer side thereof, said coating extending laterally beyond said first longitudinal edge of said scrim to form a second overhang;
(e) slitting said flattened tube to form said sheet of coated scrim.

4. The method of claim 3 wherein said slitting of step (e) is done along said second longitudinal edge.

5. The method of claim 3 further including, after step (e), the step of opening said sheet.

6. The method of claim 3 wherein said first and second overhangs are bonded together.

7. The method of claim 3 wherein said coatings are plastic films and said step of applying said coatings is done by means of extrusion.

8. The method of claim 3 wherein said coatings are plastic films and said step of applying said coatings is done by means of laminating with the use of heat.

9. A sheet of coated scrim made by the method of claim 3.

10. The sheet of claim 9 wherein said scrim comprises woven plastic tapes.

11. The sheet of claim 9 wherein said sheet has a width of 381 cm or more.
